(19) United States
(12) Patent Application Publication
(10) Pub. No.: US 2007/0080581 A1
(43) Pub. Date: Apr. 12, 2007

(54) Auxiliary braking system

(76) Inventors: Der-Cherng Liaw, Tucheng City (TW); Wei-Chao Chen, Tainan City (TW); Wen-Ching Chung, Gukeng Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,852

(22) Filed: Dec. 7, 2006

(30) Foreign Application Priority Data
Sep. 12, 2005 (TW) 94143630

(51) Int. Cl. B60T 17/16

(52) U.S. Cl. 303/89; 188/265

(57) ABSTRACT

The present invention discloses an auxiliary braking system, which is used to enable an actuation device having a braking interface to perform braking. The auxiliary braking system of the present invention comprises: a dynamic device controlled by a controller; a linking device coupled to the dynamic device; and a motion block installed at the linking device and able to contact the braking interface of the actuation device. When the dynamic device is initiated, the motion block is driven by the linking device to trigger the actuation device to perform braking. The auxiliary braking system of the present invention can be applied to a common vehicle to replace all-manual braking operation and make driving easier with high installation convenience without changing the original structure of the vehicle.

### BACKGROUND OF THE INVENTION

1. Field of the Invention

The present invention relates to an auxiliary braking system, particularly to a smart, high-security and easy-installation automatic auxiliary braking system.

2. Description of the Related Art

With the promotion of living standard, the rate of car ownership has been very high in Taiwan. In addition to safety and convenience, the current automobile industry has been also focused on automatic design and humanistic design. Especially, automatic driving is an obvious trend in the development of future cars. The automatic driving technology includes: the automatic steering system, the automatic acceleration system and the automatic braking system.

As to modern electronic braking systems, a Taiwan patent publication No. 96559 proposed an “Automatic Operating System for Railway Vehicles”, which periodically provides a train running on a fixed path with the static information to effectively operate the train. According to that patent, each train has a signal information receiving device, a static information receiving and storing device and a speed and distance measuring device. According to the stored static information and the received information, the vehicle control system of the train generates control signals to operate the braking systems and the electric machines of the train. However, such a technology cannot be applied to common vehicles but only to the train running on a fixed path.

At present, the automobile manufacturers commonly focus on safety-enhancing electronic braking systems, such as the Anti-lock Braking system (ABS). Some luxury cars have a braking system, which detects the driver's pushing force on the brake pedal and transforms the force into the physical braking force. However, the abovementioned technologies need to modify both existing electronic and mechanical systems of a vehicle on a large scale. It is uncommon to find a non-built-in auxiliary braking device. Although the mechanical structures of the electronic braking devices developed by some laboratories can indeed achieve the braking function, the characteristic of being an auxiliary role is ignored. Therefore, those conventional electronic braking devices are likely to interfere with the operation of the original braking system.

Accordingly, the present invention proposes a compact auxiliary electronic braking mechanism, which does not interfere with the operation of the original braking system, to overcome the abovementioned problems.

### SUMMARY OF THE INVENTION

The primary objective of the present invention is to provide an automatic auxiliary braking system, which can be applied to a common vehicle with high installation convenience without changing the original structure of the vehicle.

Another objective of the present invention is to provide an automatic auxiliary braking system, which can replace all-manual braking operation and make driving easier.

Further objective of the present invention is to provide an automatic auxiliary braking system, which utilizes an external speed sensor or an external driving-status sensor to implement the automatic braking function of a running vehicle.

According to one aspect, the auxiliary braking system of the present invention is used to enable an actuation device to perform braking. The auxiliary braking system of the present invention has a dynamic device, which is connected to a linking device and controlled by a controller. A motion block is installed to the linking device and is able to contact a braking interface installed in the actuation device. When the dynamic device is initiated to operate, the linking device drives the motion block to trigger the actuation device to perform braking.

To enable the objectives, technical contents, characteristics and accomplishments of the present invention to be easily understood, the embodiments of the present invention are to be described in detail in cooperation with the attached drawings below.

### BRIEF DESCRIPTION OF THE DRAWINGS

FIG. 1 is a block diagram showing the architecture of the present invention;

FIG. 2 is a perspective view of the present invention;

FIG. 3 is a schematic diagram that the present invention is applied to vehicle braking; and

FIG. 4 is a block diagram showing the architecture that the present invention combined with a computer is applied to vehicle braking.

### DETAILED DESCRIPTION OF THE INVENTION

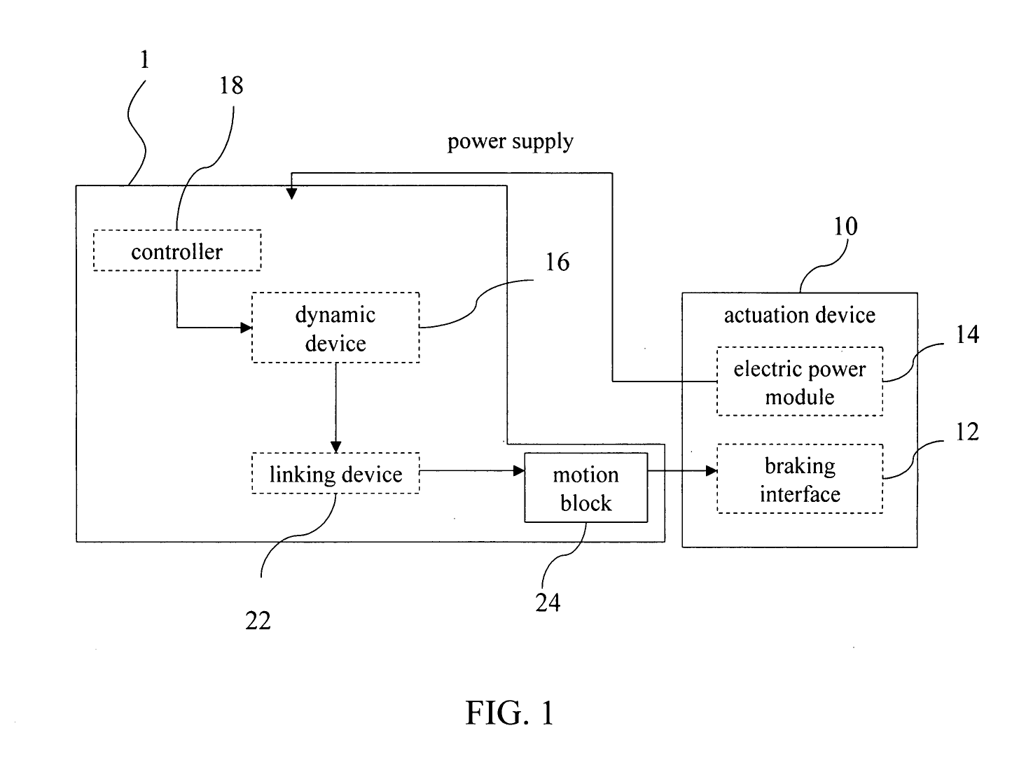

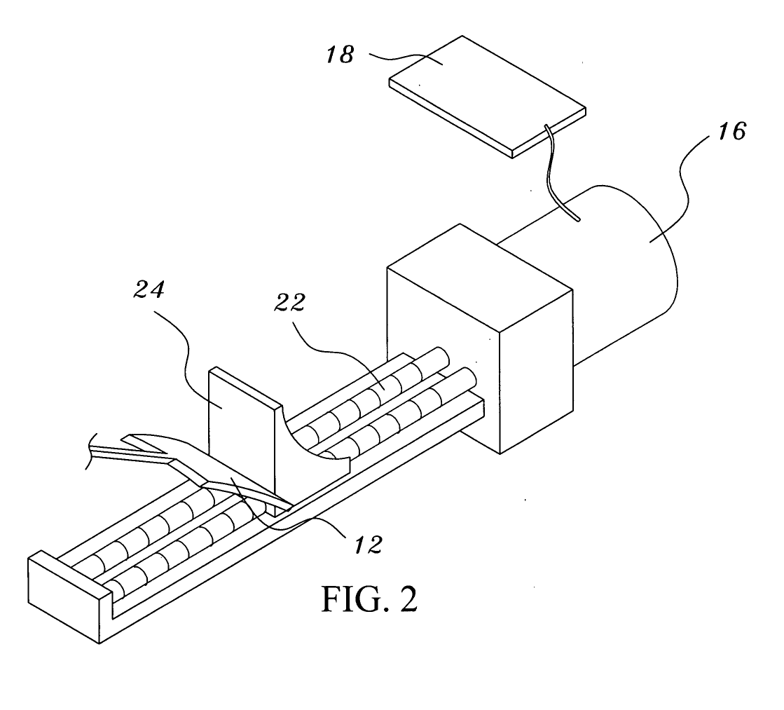

Refer to FIG. 1 and FIG. 2. The auxiliary braking system 1 of the present invention enables an actuation device 10 to perform breaking. The actuation device 10 may be a vehicle braking device, a machine table braking device or a machine operated with a pedal such as a boiler or a cutting machine. The actuation device 10 has a braking interface 12 to perform braking operation, such as the brake pedal of a vehicle. The actuation device 10 also has an electric power module 14 to provide power for the actuation device 10 and the auxiliary braking system 1. The auxiliary braking system 1 is to be described in detail below.

The auxiliary braking system 1 comprises: a dynamic device 16, a linking device 22 and a motion block 24. The dynamic device 16 is a pneumatic pump, a hydraulic pump or a motor. The dynamic device 16 is powered by the electric power module 14, and the dynamic device 16 is controlled by a controller 18 and connected to the linking device 22. The linking device 22 may be screws, belts, gears, or the combination of them. The motion block 24 is installed to the linking device 22 and can contact the braking interface 12. When the dynamic device 16 is initiated to operate, the motion block 24 is driven by the linking device 22 to trigger the actuation device 10 to perform braking. The auxiliary braking system 1 has a safety mechanism. When another object (not shown in the drawings) contacts the braking interface 12 or the motion block 24, the safety mechanism will disable the dynamic device 16. Here, the object refers to the limb of the operator. The safety mechanism may be installed in the controller 18, and the operator may coercively disable the dynamic device 16 via the controller 18. Besides, the controller 18 is controlled manually or by a computer.

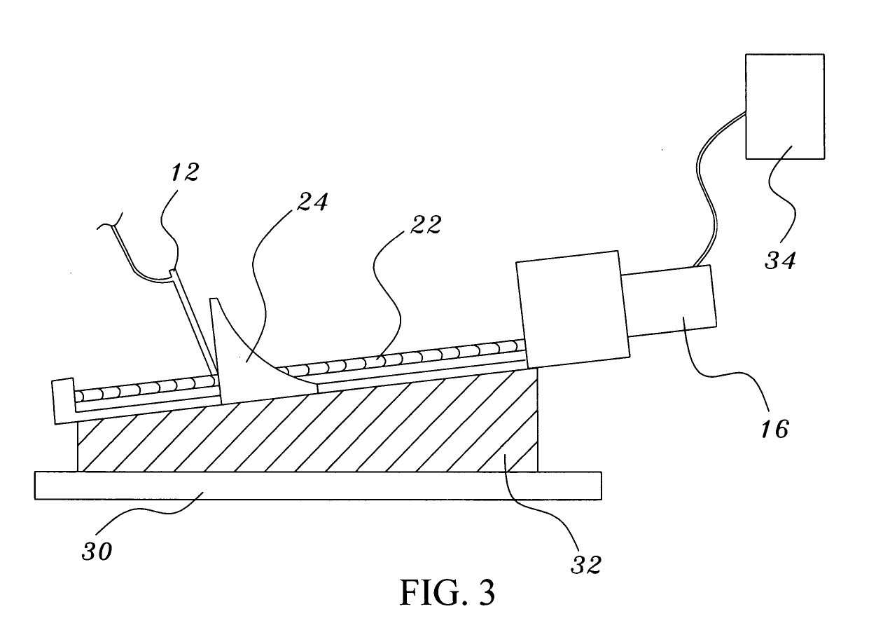

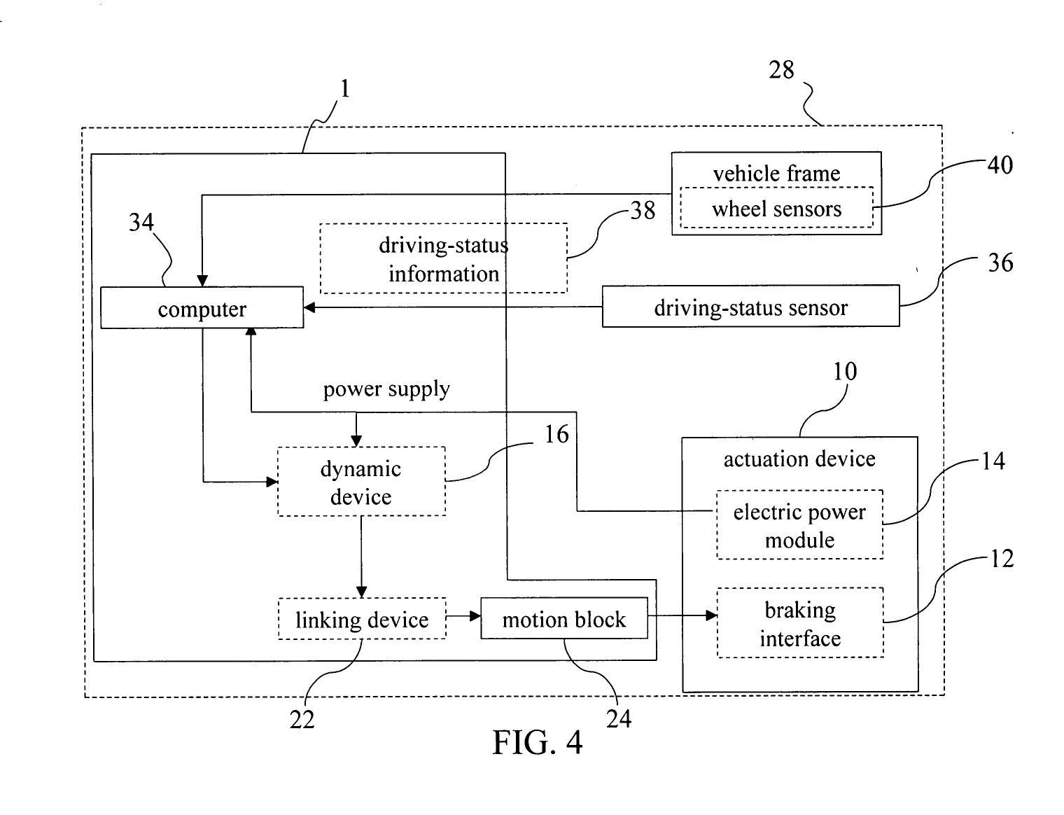

The embodiment that the auxiliary braking system applied to vehicle braking is to be used as an exemplification of the present invention. Refer to FIG. 3 and FIG. 4. A vehicle 28 has an installation board 30 below the driver seat, and with an oblique sliding seat 32 being installed on the installation board 30 to fix and support the dynamic device 16 and the linking device 22. The controller 18 may be installed in the place where the driver can operate it conveniently, such as the instrument panel or the perimeter of the steering wheel. The controller 18 is connected to a computer 34; alternatively, the computer 34 replaces the controller 18 and directly performs the control function. In this embodiment, a driving-status sensor 36 should be installed in the vehicle 28 to obtain driving-status information 38. The computer 34 calculates the required braking force with the driving-status information 38 and instructs the dynamic device 16 to operate according to the calculation results. The driving-status information 38 includes: the speed of the front vehicle and the safe distance between vehicles and/or surrounding obstacles. The electric power module 14, which provides power for the dynamic device 16, may be further powered by the electric power supply of the vehicle. Besides, the auxiliary braking system 1 has an anti-lock mechanism. To achieve the anti-lock mechanism, wheel sensors 40 are installed to the two front wheels. During the operation of the auxiliary braking system 1, if the wheel sensors 40 detect that the wheels are locked, the wheel sensors 40 will inform the computer 34. The computer 34 will then control the dynamic device 16 to drive the linking device 22 to unfasten the motion block 24 from the braking interface 12 until the wheels are released from the lock state. Once the lock state is released, the auxiliary braking system 1 resumes its braking operation.

The auxiliary braking system 1 of the present invention can replace all-manual operation and makes braking operation easier. The auxiliary braking system 1 of the present invention has high installation convenience and can be directly applied to a vehicle 28 without changing the original structure of the vehicle 28. In cooperation with an external speed sensor (for instance, an external image sensor) 36, the auxiliary braking system 1 of the present invention can achieve the automatic braking function of a running vehicle.

Those described above are the embodiments to exemplify the present invention to enable the persons skilled in the art to understand, make and use the present invention. However, it is not intended to limit the scope of the present invention. Any equivalent modification and variation according to the spirit of the present invention is to be also included within the scope of the claims stated below.

What is claimed is:

1. An auxiliary braking system for enabling an actuation device with a braking interface to perform braking, comprising:
a dynamic device controlled by a controller;
a linking device coupled to said dynamic device and transmitting dynamic power of said dynamic device; and
a motion block installed at said linking device and able to contact said braking interface and driven by said linking device to trigger said actuation device to perform braking.

2. The auxiliary braking system according to claim 1, wherein said actuation device further comprises an electric power module providing power for said dynamic device.

3. The auxiliary braking system according to claim 1, wherein said dynamic device is a pneumatic pump, a hydraulic pump or a motor.

4. The auxiliary braking system according to claim 1, wherein said linking device is screws, belts, gears, or the combination of them.

5. The auxiliary braking system according to claim 1, wherein said auxiliary braking system is applied to a vehicle braking device, a machine table braking device or a machine operated with a pedal, and said actuation device is installed in a vehicle, a machine table, or a machine.

6. The auxiliary braking system according to claim 5, wherein said machine is a boiler or a cutting machine.

7. The auxiliary braking system according to claim 5, wherein when said auxiliary braking system is applied to a vehicle braking device, an installation board is installed to said vehicle and used to fix said auxiliary braking system.

8. The auxiliary braking system according to claim 7, wherein said installation board utilizes an oblique sliding seat to fix and support said linking device and said dynamic device.

9. The auxiliary braking system according to claim 5, wherein when said auxiliary braking system is applied to a vehicle braking device, said auxiliary braking system has an anti-lock mechanism, and at least one wheel sensor is installed to a wheel; during operation of said auxiliary braking system, if said wheel sensor detects that said wheel is locked, said wheel sensor instantly informs said controller, and said controller controls said dynamic device to unfasten said braking interface until said wheel is released from a lock state; once said lock state is released, said auxiliary braking system resumes its braking operation.

10. The auxiliary braking system according to claim 5, wherein when said auxiliary braking system is applied to a vehicle braking device, said controller is operated by a computer, and a driving-status sensor is installed to said vehicle and used to obtain driving-status information; said computer calculates required braking force according to said driving-status information and provides a plurality of calculation results for said dynamic device; and said dynamic device performs braking operation according to said calculation results.

11. The auxiliary braking system according to claim 10, wherein said driving-status information includes: a relative speed and a safe distance between vehicles and/or surrounding obstacles.

12. The auxiliary braking system according to claim 1, wherein said auxiliary braking system has a safety mechanism for disabling said dynamic device when another object contacts said braking interface.

13. The auxiliary braking system according to claim 12, wherein said object refers to limbs of operator.

14. The auxiliary braking system according to claim 12, wherein said safety mechanism is installed at said controller.

15. The auxiliary braking system according to claim 1, wherein said controller is operated manually or by a computer.
